(19) United States
(12) Patent Application Publication
(10) Pub. No.: US 2007/0199260 A1
(43) Pub. Date: Aug. 30, 2007

(54) MODULAR DECORATIVE TRIM SYSTEM AND METHOD

(76) Inventor: James C. Jensen, Long Branch, NJ (US)

Correspondence Address: GREENBERG TRAURIG, LLP, MET LIFE BUILDING, 200 PARK AVENUE, NEW YORK, NY, 10166, US

(21) Appl. No.: 11/673,839

(22) Filed: Feb. 12, 2007

Related U.S. Application Data
(60) Provisional application No. 60/772,673, filed on Feb. 13, 2006.

(51) Int. Cl. E06B 1/04

(52) U.S. Cl. 52/204.1

(57) ABSTRACT

Various embodiments of the present invention provide modular decorative trim. The trim may comprise interconnecting segments which are assembled to provide a decorative, adjustable header molding for mounting on top of a door or window, for example. In one example, installation of the heading molding may comprise affixing a first side section to a surface using double-sided adhesive tape, telescopingly sliding a central section over the first side section, telescopingly sliding a second side section into the central section, affixing the second side section to the surface, and adjusting the central section to be centrally located with respect to the two side sections.

### RELATED APPLICATIONS

This application claims the benefit of U.S. Provisional Application Ser. No. 60/772,673, filed Feb. 13, 2006, which is incorporated herein by reference in its entirety.

### FIELD OF THE INVENTION

One embodiment of the present invention relates to a modular system for use as decorative trim. In one example, the present invention relates to a modular system having interconnecting segments which are assembled together to provide a decorative trim of variable width on top of a door or window, for example.

### BACKGROUND OF THE INVENTION

Decorative trim that is placed above the molding over a door or window is commonly referred to as header molding. Similar to regular molding, header molding is typically composed of natural or processed wood, or plastic. It is typically of one-piece construction, relatively weighty, ornate, and of notable cost.

Typical installation of header molding first requires making sure that the molding is of the correct desired width. If the molding is required to be trimmed in order to adjust it's width, given it's ornamental purpose, as well as it's cost, great care must be taken to trim the molding properly and evenly, without damaging it.

Next, mounting the molding in place is typically done with fasteners such as nails or screws. Care must be taken in the installation of such fasteners through the header molding and into the wall so as not to significantly diminish the decorative appearance of the header molding while assuring that the fasteners have enough purchase strength in the wall to retain the header molding in place.

Throughout the installation process, there are numerous opportunities to damage the header molding.

### BRIEF DESCRIPTION OF THE DRAWINGS

FIG. 1 is a front elevational view of modular decorative trim according to an embodiment of the present invention (depicted as oriented over the top molding of a door);

FIG. 2 is an exploded front view of the modular decorative trim of FIG. 1;

FIG. 3 is an exploded back view of the modular decorative trim of FIG. 1;

FIG. 4 is an exploded top view of the modular decorative trim of FIG. 1;

FIG. 5 is an exploded perspective view of a portion of the modular decorative trim of FIG. 1;

FIG. 6 is a sectional side view of the modular decorative trim cut away along lines 6-6 in FIG. 1; and

FIGS. 7-11 show a frame according to another embodiment of the present invention (FIG. 7 is an exploded view of the frame, FIGS. 8 and 10 show the frame of FIG. 7 in a larger (less overlapped) configuration, and FIGS. 9 and 11 show the frame of FIG. 7 in a smaller (more overlapped) configuration).

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As described herein various embodiments of the present invention provide a decorative, inexpensive, light weight, adjustable, and easy to install header molding.

One embodiment of the present invention is directed to a modular decorative trim comprising a first side section, a central section, and a second side section. In one example, the three sections of the trim are arranged linearly in an overlapping and telescopingly adjustable manner with respect to each other, and the trim is adapted for mounting to a surface, such as, for example, a wall.

In one example, the first side section and second side section may each comprise a bottom, front, top, and back. The fronts of the first and second side sections may have shapes which are essentially identical to each other, and need not be flat. Further, at least a portion of the front of the central section may have a shape that is essentially identical to the shapes of the fronts of the first and second side sections. The front of the central section may also comprise an ornamental feature. The first and second side sections may be configured such that they are interchangeable with each other on either side of the central section.

The backs of the first and second side sections may comprise adhesive surfaces to facilitate mounting the modular decorative trim to a surface such as, for example, a wall. The adhesive surfaces may be double-sided adhesive tape.

In one example, the tops of the first and second side sections may comprise measurement markings, and the markings may indicate fractional and/or full inch or centimeter scales.

The modular decorative trim may further comprise a gasket. The gasket may comprise a skirt and an integral head, and may be formed of a soft resilient material.

In another example, a method of installing the modular decorative trim comprises positioning the first side section against a surface and affixing it thereto (such as, for example, by using double-sided adhesive tape), attaching the central section to the first side section, attaching the second side section to the central section, positioning the second side section against the surface and affixing it thereto (such as, by example, by using double-sided adhesive tape), and aligning the central section with respect to the first and second side sections. In another example, the gasket may be positioned below the modular decorative trim to promote overall uniformity and linearity of appearance of the installed modular decorative trim.

In another example, attaching the central section to the first side section may be done by sliding the central section over the first side section in a telescoping manner. Further, attaching the second side section to the central section may be done by sliding the second side section into the central section in a telescoping manner. Additionally, aligning the central section with respect to the first and second side sections may be accomplished by centrally positioning the central section by using markings located on the first and second side sections.

In another example, a method of installing the modular decorative trim comprises measuring a desired length for the trim, such as measuring the width of a door or window along with the surrounding molding, assembling the first side section with the central section in a telescoping manner, assembling the central section with the second side section in a telescoping manner, adjusting the first and second side sections relative to the central section until the markings on the first and second side sections correspond to the desired length, and affixing the first and second side sections to a desired surface. Affixing can be effectuated, for example, by utilizing double-sided adhesive tape. Again, a gasket may be positioned below the modular decorative trim to promote overall uniformity and linearity of appearance of the installed modular decorative trim.

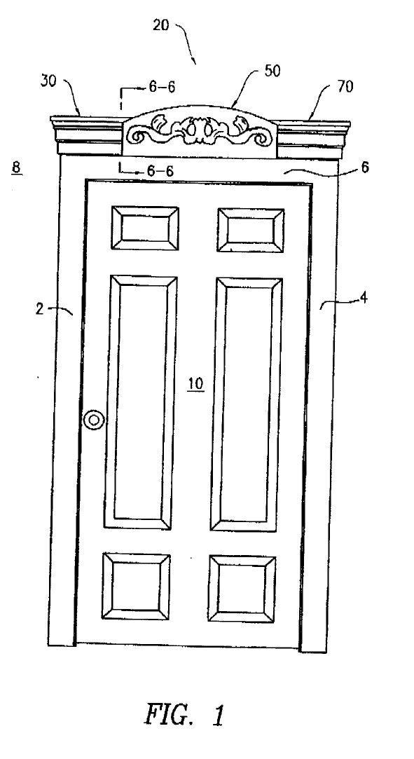

Referring now to FIG. 1, this FIG. depicts modular decorative trim according to an embodiment of the present invention, identified as header 20 for convenience. Header 20 comprises three sections referred to as a first end section 30, central section 50, and second end section 70. The header 20 is depicted as mounted to a wall 8 over a door 10. More specifically, door 10, as is commonly known in the art, is surrounded by a left molding 2, right molding 4, and top molding 6, and header 20 is installed over the top molding 6 to further decorate the doorway.

As will be discussed in more detail, below, the three sections 30, 50, and 70 of the header 20 are arranged to move telescopically relative to each other, thereby facilitating the adjustability in the overall length of the header 20.

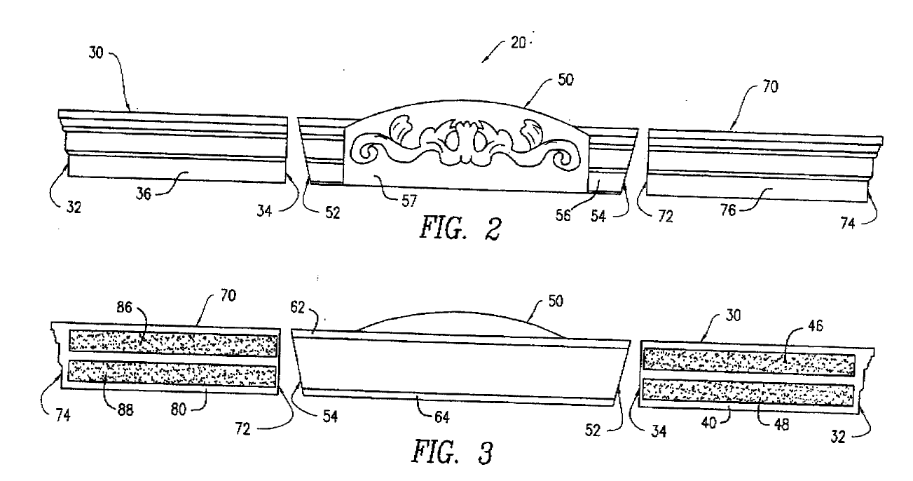

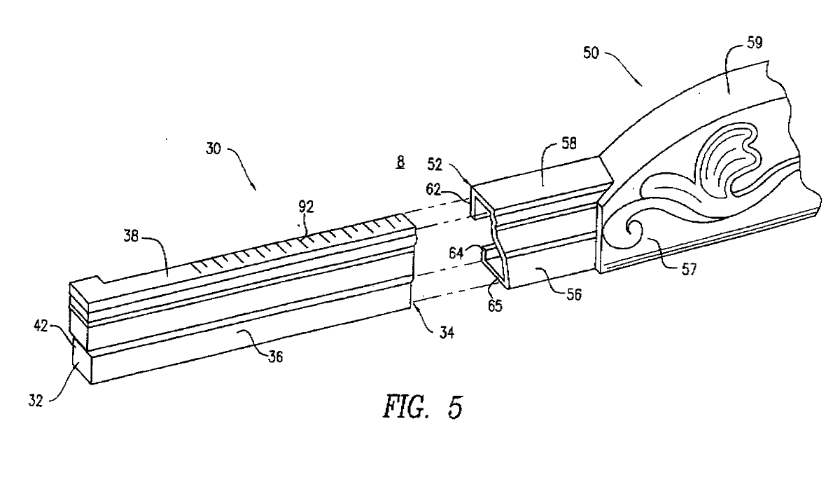

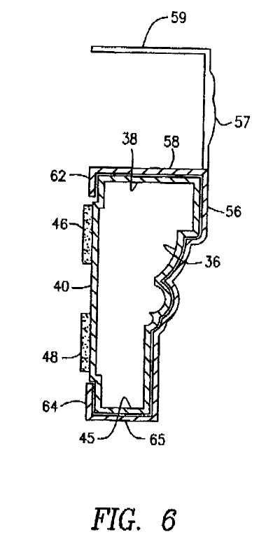

Referring to FIGS. 2-6, the three sections of the header 20 are depicted separately in their respective orientations relative to each other. Generally, the first side section 30 comprises a first end 32 forming a side 42 (see FIG. 5), a second open end 34 opposite the first end 32, a front 36, top 38, and a back 40 (see FIG. 6—a cross section through the overlap of first side section 30 and central section 50 (showing both the overlap and the upper portion of central section 50)). The central section 50 comprises a first open end 52, a second open end 54, a front 56 which also has an optional ornamental feature 57 thereon, tops 58 and 59, a back top lip 62, and a back bottom lip 64. Further, the second side section 70 comprises a first open end 72, a second end 74 forming a side 84 similar to side 42, a front 76, top 78, and back 80.

The first and second ends 52, 54 of the central section 50 are dimensioned slightly larger in cross-section than the first and second side sections 30 and 70 such that the first and second side sections 30 and 70 snugly fit inside, and are able to move telescopically relative to the central section 50, thus enabling lengthwise adjustment of the header 20. More specifically, the second end 34 of the first side section 30 is inserted into the first end 52 of the central section 50 such that the front 56, top 58, back top and bottom lips 62, 64, and bottom 65 of the central section 50 ride over the respective front 36, top 38, back 40, and bottom 45 of the first side section 30. Similarly, the first end 72 of the second side section 70 is inserted into the second end 54 of the central section 50 such that the front 56, top 58, back top and bottom lips 62, 64, and bottom 65 of the central section 50 ride over the respective front 76, top 78, back 80, and bottom (not shown) of the second side section 70.

When assembled, the three sections 30, 50, and 70 form the header 20 which may have telescoping ability, and an integral and ornamental appearance. The extent of the telescoping distance of the header 20 is governed by the length of each section 30, 50, and 70 together with the amount of overlap between each of the first and second side sections 30 and 70 with the central section 50.

With reference to FIG. 3, one option (which is intended as illustrative and not restrictive) for affixing the header 20 to the wall 8 is to use double-sided adhesive strips 46, 48 and 86, 88 on the backs 40, 80 of the first and second side sections 30, 70. Once the header 20 is properly aligned in its desired mounting position, the adhesive on the strips 46, 48, 86, 88 may be exposed so as to bind the first and second side sections 30 and 70 to the wall 8.

Of course, it is recognized that other affixing means may be employed instead of (or in addition to) adhesive strips 46, 48, 86, 88 in order to bind the first and second side sections 30, 70 to the wall 8. For example, hooks and loops, otherwise known as Velcro, may be used, thus facilitating easy subsequent interchangeability of the installed header with a different header.

By virtue of the contoured, close fitting, telescoping connection between the central section 50 and the side sections 30 and 70, as is shown, for example, in FIGS. 5 and 6 between the first side section 30 and the central section 50, the central section 50 remains firmly in position straddling sections 30 and 70, thus forming a rigid header 20 with an integral appearance. The rigidity of the header 20 may be further enhanced by optionally having the top 58 of central section 50 extend continuously from the first end 52 to the second end 54 of the central section 50.

Mechanically, this creates a central section having more resistance to twisting and bending forces. Thus, with reference to FIGS. 5 and 6, top 58 may run underneath top 59 of the central section 50.

Installation of the header 20 above a door or window can be achieved in various steps. One example approach involves orienting the first side section 30 into its desired position on the left side over the door and affixing it in place. Next, the central section 50 may be telescopingly assembled with the first side section 30. Then, the second side section 70 may be telescopingly assembled with the central section 50. The second side section 70 may then be horizontally oriented into its desired position on the right side over the door, and affixed in place. Once the positions of the first and second side sections 30, 70 are fixed, the central section 50 may be horizontally adjusted while riding over sections 30 and 70, until it is centrally positioned, at which point installation would be complete. Of course, it is recognized that the installation of the header 20 may be achieved in numerous other ways and sequences of steps.

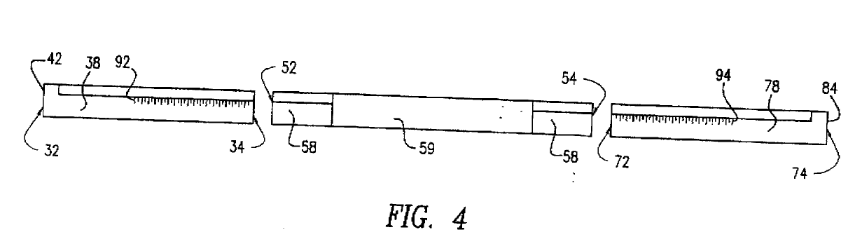

In one example, to facilitate positioning the central section 50 in the middle of the header 20, the first and second side sections 30, 70 may be provided with markings 92, 94 on their respective tops 38, 78, such as on a ruler, as is depicted in FIGS. 4 and 5. These markings 92, 94 may aid in centrally positioning the central section 50 by readily facilitating the measurement of the amount of overlap of the central section 50 over each of the first and second side sections 30, 70, and allowing for adjustment so as to have equal overlapping lengths.

In one example, markings 92, 94 may be identified with a modified scale wherein numbers denoting the markings would increase from the first end 32 to the second end 34 of the first side section 30, and similarly, like numbers would increase from the second end 74 to the first end 72 of the second side section 70. The spacing of the markings would be at half-inch intervals (for example), and the numbers denoting each marking would correlate to full inches. Thus, movement of the first side section 30 away from the central section 50 by half of an inch, and movement of the second side section 70 away from the central section 50 by half of an inch, will result in the expansion of the header 20 by a total of one inch.

In one example, when the central section 50 is aligned on the same marking on each of the first and second side section 30, 70, that marking will indicate the total length of the header 20 from the first end 32 of the first side section 30 to the second end 74 of the second side section 70. Thus, when a measurement is taken to determine the length of the header 20 that is desired, for example measuring the width of a door or window along with the widths of the molding on either side thereof, the header 20 can then be dialed-in to that measurement by adjusting the central section 50 vis-à-vis the first and second side sections 30, 70. For example, if the header has to be 36 inches wide, based on a measurement of the width of a door and moldings, then the central section 50 should be aligned with each of the first and second side sections 30, 70 so that the marking with the number 36 on each of the first and second side sections 30, 70 is indicated. This will mean that the header 20 has been adjusted to be 36 inches wide, at which point it may then be affixed to the wall or any other surface for which it is intended.

In another example, the first and second side sections may have sides on each of their first and second ends. That is, as seen in FIG. 5, the first side section 30 has a side 42 on its first end 32, but may also have a similar side on its second end 34. Likewise, the second side section 70 has a side 84 on its second end 74, but may also have a similar side on its first end 72. As such, the first and second side sections 30, 70 would be symmetrical, and thus interchangeable, thereby being able to be used on either side of the central section 50.

FIGS. 2-5 depict the first and second ends 52, 54 of the central section 50 as being at oblique angles, as opposed to the second end 34 of the first side section 30, or the first end 72 of second section 70, which are at right angles. It is recognized that the first and second ends 52, 54 of the central section 50 may be at any angles (as may be the ends of the first and second side sections 30,70). Of course, oblique angles may tend to form seams that are less noticeable than seams formed at right angles.

In another example, and in contrast with FIG. 5, an alternative central section may have first and second ends located on either side of the ornamental feature and these ends may conform to the shape and angle of the sides of the ornamental feature. Thus, in contrast with central section 50, the protrusions on either side of the alternative central section may be eliminated. Since the width of the ornamental feature may be slightly wider than the width of the first and second side sections, when the first and second sections are assembled with the central section, no seam is visible.

It is noted that the ornamental feature 57 on central section 50 is optional, and if present, may be of any shape, size, texture, color, and appearance. Similarly, the facades of the three sections 30, 50, and 70 may be of any shape, size, texture, color, and appearance, so long as the telescoping ability of the header 20 is not significantly compromised.

It is further noted that the header 20 is not limited to being comprised of three sections. For example, the header 20 may be comprised of multiple sections arranged in any telescoping order, as desired. For example, a cover may be formed in the following arrangement: Side section, central section, side section, central section, side section.

The material comprising the header 20 may be any material suitable to accomplish the header's purpose. For example, the header 20, or at least any of the portions thereof, may be made from any commonly known thin, lightweight plastic material, and may be vacuum formed. A modular molding system designed in this manner is disclosed in U.S. Pat. No. 6,477,818 to Jensen, the entire disclosure of which is expressly incorporated by reference herein.

In another example, a gasket may be provided to enhance the overall ornamental appearance of the header 20. The gasket may comprise a generally hollow cylinder and may be formed from a soft resilient material. In the course of installing the header 20, the gasket may be placed in between the header 20 and the top molding 6 of the door 10. More specifically, the gasket may be sandwiched between the header 20 and top molding 6. A portion of the gasket may protrude to or past the front edges of the header and molding. The gasket may provide a conforming surface that facilitates evening-out and hiding non-uniformities and thickness variations that may be present on the top surface of the top molding 6 as well as the bottom surface of the header 20. Additionally, the gasket may allow for the seam between the header 20 and top molding 6 to be concealed behind it. The gasket may also accommodate any differential along a bottom edge between the central section 50 and side sections 30 and 20. Thus, the gasket may promote overall uniformity and linearity of appearance of an installed header 20. Of course, gaskets having other shapes and/or materials may be utilized.

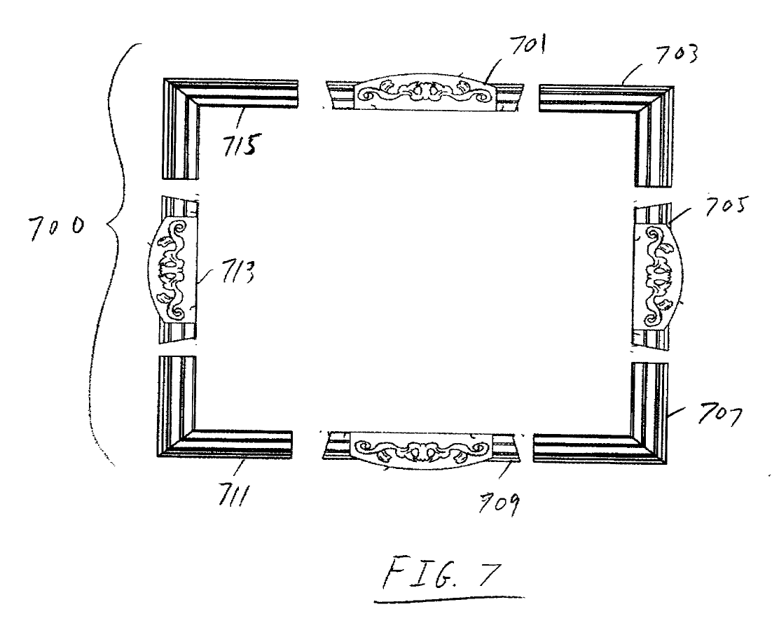

Referring now to FIGS. 7-11, another embodiment of the present invention is shown. As seen in these FIGS. 7-11, a frame 700 may be provided. In one example frame 700 may be disposed on a wall around a window. In another example frame 700 may be disposed on a wall around a flat panel television set.

In any case, it is seen in FIG. 7 (showing an exploded view) that frame 700 may comprise upper section 701, upper-right corner 703, right section 705, lower-right corner 707, lower section 709, lower-left corner 711, left section 713, and upper-left corner 715 (of course, any desired number of pieces may be utilized).

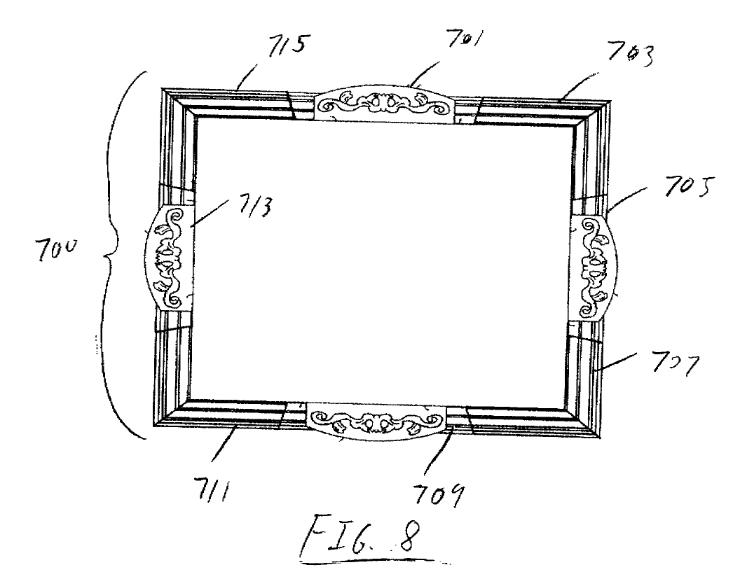

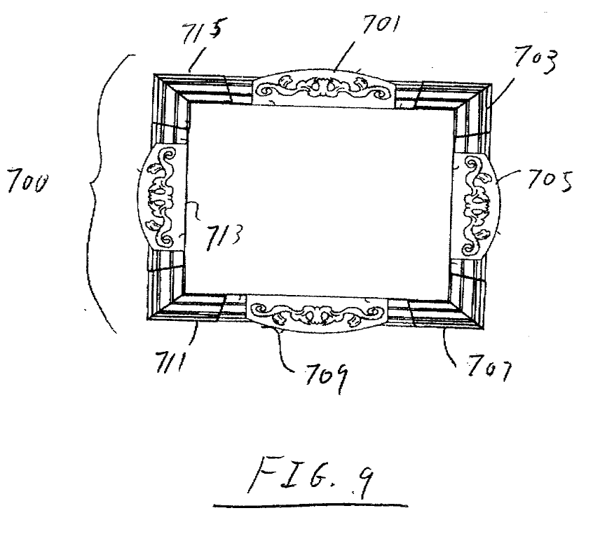

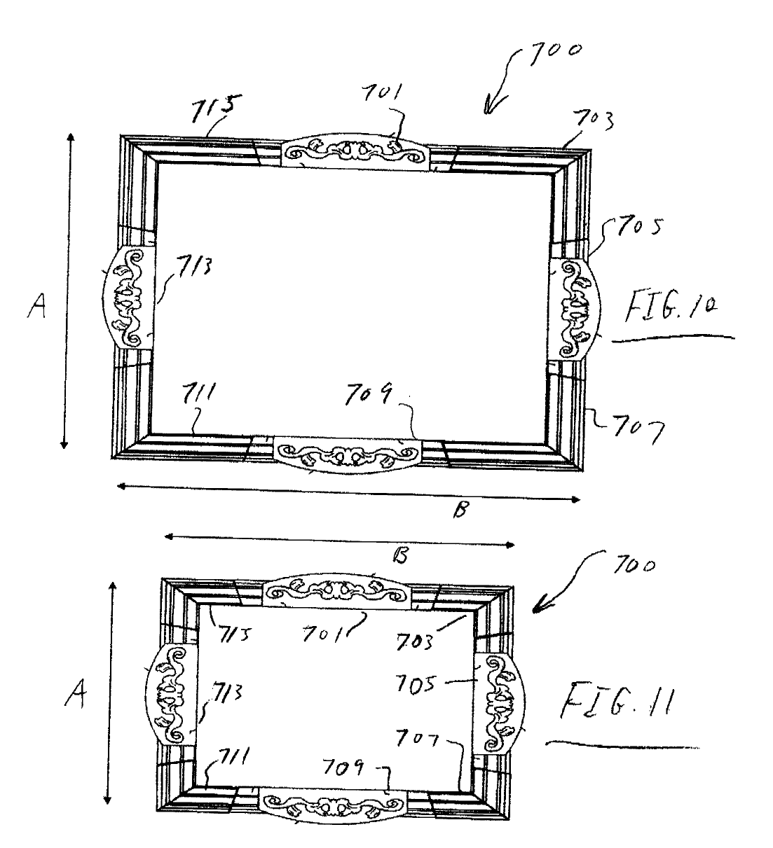

Each of the sections may be arranged in an overlapping and telescoping relationship as described above. In this regard, attention is directed to FIGS. 8-11, which show frame 700, in FIGS. 8 and 10, in a larger (less overlapped) configuration and in FIGS. 9 and 11, in a smaller (more overlapped) configuration (arrows A of FIGS. 10 and 11 show how the size of frame 700 may be adjusted in the vertical direction and arrows B of FIGS. 10 and 11 show how the size of frame 700 may be adjusted in the horizontal direction).

In one example, the sections may be biased inward (e.g., via use of bungee cords, rubber bands, springs, etc.). Such biasing may allow the frame 700 to be enlarged, placed around an object (e.g., a flat screen television set) and then compressed down in size by the biasing mechanism to stay in place around the object. In one specific example, there may be: (a) an upper biasing mechanism connecting the upper-left and upper-right corners, (b) a lower biasing mechanism connecting the lower-left and lower-right corners, (c) a right-side biasing mechanism connecting the upper-right and lower-right corners, and (d) a left-side biasing mechanism connecting the upper-left and lower-left corners.

In another example, the frame may be telescopic in only one dimension. In another example, the frame may be telescopic in two dimensions.

While a number of embodiments of the present invention have been described, it is understood that these embodiments are illustrative only, and not restrictive, and that many modifications may become apparent to those of ordinary skill in the art. For example, any section may overlay any other section(s). Further, one or more sections may be interchangeable. Further still, any desired number of sections may be utilized. Further still, the various steps may be carried out in any desired order (and any desired steps may be added and any desired steps may be eliminated).

What is claimed is:

1. A modular trim system for installation adjacent a building feature, comprising:
at least a first side section, a second side section, and a central section;
wherein the first side section is arranged in an overlapping and telescoping manner with respect to the central section;
wherein the second side section is arranged in an overlapping and telescoping manner with respect to the central section; and
wherein the first side section, the second side section and the central section are configured to be adjustable to span a distance between a first side of the building feature and a second side of the building feature.

2. The system of claim 1, wherein the building feature is selected from the group consisting of a door and a window.

3. The system of claim 1, wherein at least one of the first side section and the second side section comprises measurement markings.

4. The system of claim 3, wherein each of the first side section and the second side section comprises measurement markings.

5. The system of claim 4, wherein the measurement markings are disposed at the top of each of the first side section and the second side section.

6. The system of claim 4, wherein the measurement markings aid in adjusting overlap of the first side section with the central section and overlap of the second side section with the central section in order to adjust the total length from a first end of the first side section opposite the central section to a first end of the second side section opposite the central section.

7. The system of claim 4, wherein the measurement markings aid in adjusting overlap of the first side section with the central section and overlap of the second side section with the central section in order to center the central section between a first end of the first side section opposite the central section and a first end of the second side section opposite the central section.

8. The system of claim 4, wherein the measurement markings comprise fractional and full inch markings.

9. The system of claim 4, wherein the measurement markings comprise metric markings.

10. The system of claim 1, wherein the first side section and the second side section are interchangeable with one another on either side of the central section.

11. The system of claim 1, further comprising a gasket disposed below at least a part of at least one of the first side section, the second side section and the central section.

12. The system of claim 1, wherein at least one of the first side section and the second side section has adhesive disposed on a back thereof.

13. The system of claim 12, wherein each of the first side section and the second side section has adhesive disposed on a back thereof.

14. The system of claim 13, wherein the adhesive is double-sided adhesive tape.

15. The system of claim 1, wherein the center section overlaps each of the first side section and the second side section.

16. The system of claim 1, wherein the center section is overlapped by each of the first side section and the second side section.

17. A method of installing a modular trim system adjacent a building feature, comprising:
positioning a first side section against a surface;
affixing the first side section to the surface;
attaching a central section to the first side section;
attaching a second side section to the central section;
positioning the second side section against the surface; and
affixing the second side section to the surface;
wherein the first side section is arranged in an overlapping and telescoping manner with respect to the center section;
wherein the second side section is arranged in an overlapping and telescoping manner with respect to the center section; and
wherein the first side section, the second side section and the central section are configured to be adjustable to span a distance between a first side of the building feature and a second side of the building feature.

18. The method of claim 17, wherein the building feature is selected from the group consisting of a door and a window.

19. The method of claim 17, further comprising aligning the central section with respect to the first side section and the second side section.

20. The method of claim 17, wherein the step of affixing the first side section to the surface comprises affixing the first side section to the surface with double-sided adhesive tape and wherein the step of affixing the second side section to the surface comprises affixing the second side section to the surface with double-sided adhesive tape.

21. The system of claim 17, wherein the center section overlaps each of the first side section and the second side section.

22. The system of claim 17, wherein the center section is overlapped by each of the first side section and the second side section.

23. A method of installing a modular trim system adjacent a building feature, comprising:
arranging a first side section in an overlapping and telescoping manner with respect to a central section;
arranging a second side section in an overlapping and telescoping manner with respect to the center section;
positioning the first side section against a surface;
affixing the first side section to the surface;
positioning the second side section against the surface; and
affixing the second side section to the surface;
wherein the first side section, the second side section and the central section are configured to be adjustable to span a distance between a first side of the building feature and a second side of the building feature.

24. The method of claim 23, wherein the building feature is selected from the group consisting of a door and a window.

25. The method of claim 23, further comprising aligning the central section with respect to the first side section and the second side section.

26. The method of claim 23, wherein the step of affixing the first side section to the surface comprises affixing the first side section to the surface with double-sided adhesive tape and wherein the step of affixing the second side section to the surface comprises affixing the second side section to the surface with double-sided adhesive tape.

27. The method of claim 23, wherein the center section overlaps each of the first side section and the second side section.

28. The method of claim 23, wherein the center section is overlapped by each of the first side section and the second side section.

29. A frame for installation adjacent an object, comprising:
at least a top section, an upper-right corner section, a right-side section, a lower-right corner section, a lower section, a lower-left corner section, a left-side section, and an upper-left corner section; wherein each of the sections is arranged in an overlapping and telescoping manner with respect to at least one of the other sections; and
at least one biasing mechanism that biases the frame inward in at least one dimension.

30. The frame of claim 29, wherein the biasing mechanism biases the frame inward in two dimensions.

31. The frame of claim 29, wherein the object is a television set.
